(19) United States
(12) Patent Application Publication
(10) Pub. No.: US 2002/0091566 A1
(43) Pub. Date: Jul. 11, 2002

(54) Method and system for utilizing a telephone as a consumer request device for issuing promotions

(75) Inventor: Cary Siegel, Palm Harbor, FL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Catalina Marketing International, Inc., St. Petersburg, FL (US)

(21) Appl. No.: 09/756,745

(22) Filed: Jan. 10, 2001

(51) Int. Cl. G06F 17/60; H04M 1/64; H04M 11/00

(52) U.S. Cl. 705/14; 379/88.01; 379/88.18

(57) ABSTRACT

A system, method, and computer program product for requesting promotions in which a customer is connected, using an interactive voice response system and a telephone, to a host computer including a promotion database of promotions available to consumers on an unrestricted basis. The host computer determines, in response to receiving promotional request information from the consumer, requested promotions from the available promotions and issues requested promotions to the consumer. When the consumer is a frequent user, the host computer determines a promotion offer list based on the consumer's shopping preference and presents the offer list to the consumer for consumer selection of promotions. Alternatively, the host computer in the system, method, and computer program product contacts the customer to advertise at least one promotion available to the customer, determines from the customer the requested promotions, and issues the requested promotions to the consumer.

### BACKGROUND OF THE INVENTION

1. Field of the Invention

This invention relates to a system and method whereby a telephone is used as a consumer request device for issuing promotions to the consumer. As used herein, the word “promotion” means any offer, incentive, advertisement, commercial, coupon, and/or communication for promoting one or more goods and/or services.

2. Discussion of the Background

Manufacturers use a variety of promotions to persuade consumers to buy their products. These promotions are distributed in a number of ways including direct mailing of coupons to the consumer, in-store dispensing of coupons or promotional products (e.g., buy one and get a second free), and printing of coupons in newspapers or magazines. The customer, upon seeing a discount coupon for a product the customer wishes to buy, proceeds with the coupon to the store for redemption of the coupon upon purchase of an item.

In this process, the consumer has little control over the process. The consumer desiring a discount on a particular product has to sort through a plethora of promotions available to him from many diverse sources and select ones which most closely resemble the product the customer wishes to buy.

For some coupon collectors, the process of collecting, storing and selecting coupons may be intriguing, but the process for a consumer and the manufacturer or retailer is inherently inefficient. Part of the inefficiency develops from massive amount of coupons which are collected through this process. The consumer must sort and select before finding a particular coupon useable for the product in which the consumer desires to buy. In addition, the manufacturer or retailer in not knowing what particular products the consumer wishes to buy in a particular time period must issue redundant promotions over subsequent time periods as well as publishing many coupons which many consumers will never use.

Coupon dispensing systems have been developed to counteract some of the inefficiencies in the process. O'Brien et al. disclose a method and apparatus for selected distribution of discount coupons based on prior customer behavior, the entire contents of U.S. Pat. No. 5,832,457 are herein incorporated by reference. In this approach the retailer distributes coupons to a customer based on that customer's prior shopping behavior. Thus, the retailer is more likely to issue coupons which the customer will redeem.

Meanwhile, Major et al. disclose a method and apparatus for dispensing discount coupons in the store, the entire contents of U.S. Pat. No. 4,723,212 are herein incorporated by reference. In this technique, coupons are issued in response to the purchase of a product other than the one in which the coupon applies to.

Another approach commonly used in stores is to distribute coupons on the product shelves.

In all these approaches, however, the manufacturer generates coupons based on the likelihood that the consumer intends to utilize the coupon in some future shopping occurrence. However, these approaches do not address a problem that the coupons are distributed without certain knowledge that a consumer is about to purchase or will purchase a given product.

In current shopping practices restricted by the inefficiencies in coupon distribution, a consumer first decides a list of items in which he intends to purchase. Having no assurance that a coupon exists for any of item on the list, a consumer meticulously sorts through a coupon collection to determine if there exists an appropriate coupon. If the consumer finds an appropriate coupon, the consumer can proceed with the coupon to the store. If the consumer discovers no appropriate coupon, the consumer can still proceed to the store hoping that an in-store coupon contain a discount for the sought item. More than likely, the consumer will not find an appropriate coupon at the store and will buy the sought item without any discount promotion. In this circumstance, an opportunity to encourage the consumer to buy a particular product or to persuade the customer to purchase a competing product is lost. The retailer must wait for the consumer to expire the current product before another coupon enticement can impact the consumer's shopping behavior and only if the manufacturer or retailer has succeeded this time in placing the coupon at the consumer's disposal.

A further disadvantage, from a customer's standpoint, is that the process of collecting, sorting, and redeeming coupons is quite inconvenient. As a result many customers simply choose not to collect and redeem coupons.

Alternatively, an exemplary method and system for delivering promotions to electronic devices is described in U.S. Pat. No. 6,055,573, which is incorporated herein by reference. Methods and systems for providing promotions to consumers through a computer network are described in U.S. Pat. Nos. 5,970,469, and 6,014,634, both of which are incorporated herein by reference. These and other systems for delivering promotions use Internet protocols and database technologies. The design and implementation of various methods of database networking and Internet communications are described in Liu et al., “Managing Internet Information Services,” O'Reilly & Associates, Inc., 1994; Comer, “Internet Working with TCP/IP Volume I: Principles, Protocols, and Architecture,” 2^{nd} ed., Prentice-Hall, Inc., 1991; Comer and Stevens, “Internet Working with TCP/IP Volume II: Design, implementation, and Internals,” Prentice-Hall, Inc., 1991; Comer and Stevens, “Internet Working with TCP/IP Vol. III: Client-Server Programming and Applications,” Prentice-Hall, Inc., 1993; Khoshafian et al., “A Guide to Developing Client/Server SQL Applications,” Morgan Kaufmann Publishers, Inc.; Hamilton et al., “JDBC Database Access with Java, A Tutorial and Annotated Reference,” Addison-Wesley Pub. Co., 1997; and Francis et al., “Professional Active Server Pages 2.0,” Wrox Press Ltd., 1998; each of which is incorporated by reference herein.

Even though consumer electronic devices are popular and provide a convenient medium through which marketers can deliver promotions, the delivery of promotions to different electronic devices can result in marketers delivering the same promotion to the same consumer repeatedly through a variety of electronic and paper formats.

Another approach taken by manufacturers and retailers is the utilization of frequent shopper cards. Frequent shopper cards contain discounts for those customers who are a member of a frequent shopper program. Discounts for members in frequent shopper programs are advertised in newspapers and in in-store brochures. With these programs, the consumer no longer has to collect a physical coupon but merely presents the items with a frequent shopper card at a checkout counter and receives the appropriate discount for his belonging to the frequent shopper club. Here, once again the consumer has no way to determine if a coupon discount is available except by arriving at the store or seeing an advertisement in a publication.

Meanwhile, Nitchberger et al. disclose a paperless system for distributing, redeeming, and clearing coupons electronically on a card, the entire contents of U.S. Pat. No. 4,882,675 are herein incorporated by reference. An electronic display in the store presents to customers redeemable electronic coupons. The items purchased in the store by the customer are identified at the checkout, and any matches between the electronic coupon and the items purchased result in a credit to the customer's bill. Here, like before, the customer having created a shopping list is in search of appropriate coupons and coupon discounts. The customer has to search for coupons or other promotions corresponding to the products on the shopping list.

### SUMMARY OF THE INVENTION

Accordingly, one object of the present invention is to provide consumers with access to a promotion database pertaining to a wide variety of products.

A further object of the present invention is to provide the consumer with a promotion-request system for request of specific promotions directed to the products which the consumer desires to purchase.

Another object of the present invention is to provide the consumer with telephone access to the promotion database through an interactive voice response system. The interactive voice response system identifies either consumers who are a frequent users or consumers who are new to the promotion-request system.

Still another object of the present invention is to provide the consumer with promotion choices from a correlated product category associated with a particular group of products in which the consumer is interested in buying (i.e., alternative cereals, alternative detergent, alternative coffees, etc.).

A further object of the present invention is to provide the consumer with choices on where and how the promotion is to be issued. In one embodiment of the present invention, the promotions selected by the consumer are sent directly to the retail store where the consumer intends to buy the product. In another embodiment of the present invention, the promotion is directed directly to the consumer via electronic transmission of the promotion to a fax machine, a kiosk, or by direct mailing of the promotion to the consumer.

Still another object of the present invention is to provide a medium for manufacturers to advertise new products. In one embodiment of the present invention, the consumer upon selecting an appropriate product category, is informed of a variety of promotions available in that product category, enabling the consumer to select promotions for new products.

These and other objects of the present invention are provided for in a novel system, method, and computer program product for requesting promotions in which a customer is connected, using an interactive voice response system and a telephone, to a host computer including a promotion database of promotions available to consumers on an unrestricted basis. The host computer determines, in response to receiving promotional request information from the consumer, requested promotions from the available promotions and issues requested promotions to the consumer. When the consumer is a frequent user, the host computer determines a promotion offer list based on the consumer's shopping preference and presents the offer list to the consumer for consumer selection of promotions. Alternatively, the host computer in the system, method, and computer program product contacts the customer to advertise at least one promotion available to the customer, determines from the customer the requested promotions, and issues the requested promotion to the consumer.

Thus, the present invention provides the consumer with the advantages of utilizing a telephone as a medium for the selection of appropriate promotions targeting those products which the consumer intends to buy. Further, the promotion-request process of the present invention resides on a computer readable medium which stores data to implement the on-line promotion-request process on a computer such as a general purpose computer or network of general purpose computers.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram showing a system for the implementation of the present invention;

FIG. 2 is an illustrative table showing a promotion database according to the present invention;

FIG. 3 is a flowchart showing the promotion request method of the present invention;

FIG. 4 is a flowchart showing a computer request method of the present invention, wherein a promotion incentive offer list is generated based on shopper preference criteria;

FIG. 5 is a flowchart showing a promotion request method of the present invention, wherein the consumer is a new user;

FIG. 6 is a flowchart showing a promotion-request method of the present invention illustrating a down-selection process implemented by an interactive voice response system;

FIG. 7 is an exemplary depiction of a purchase promotion according to the present invention;

FIG. 8 is a flowchart a promotion-request method of the present invention illustrating a process wherein the consumer is contacted by an interactive voice response system to advertise promotions to the consumer; and

FIG. 9 is a schematic illustration of a computer system programmed to perform one of more of the special purpose functions of the present invention.

### DESCRIPTION OF THE EMBODIMENTS

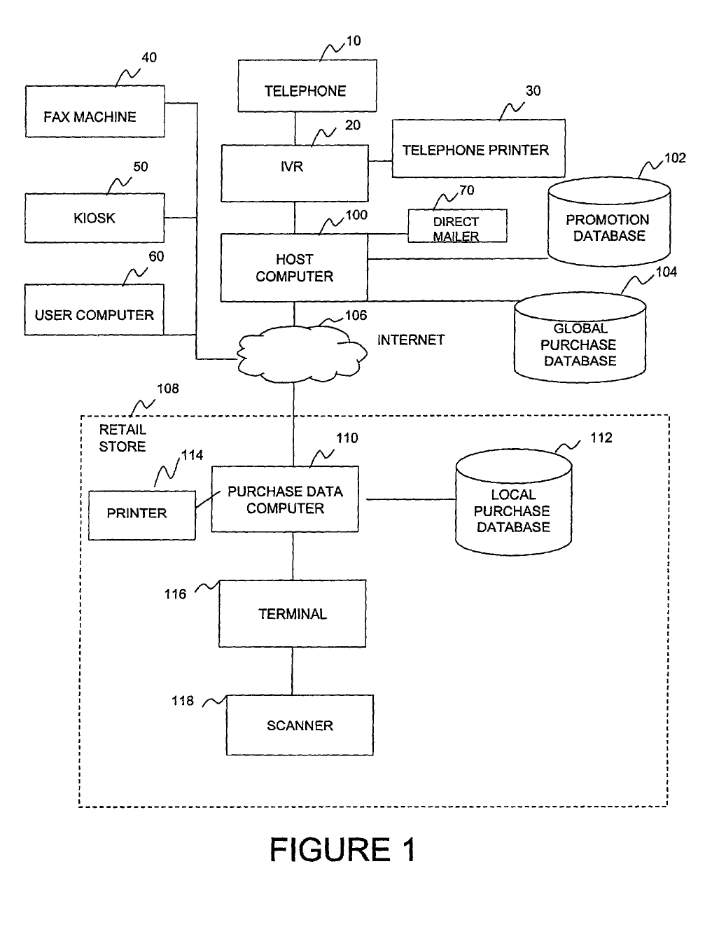

Referring now to the drawings, wherein like reference numerals designate identical or corresponding parts throughout the several views, and more particularly to FIG. 1 thereof, FIG. 1 is a block diagram showing a system for the implementation of the present invention on a general purpose computer/network.

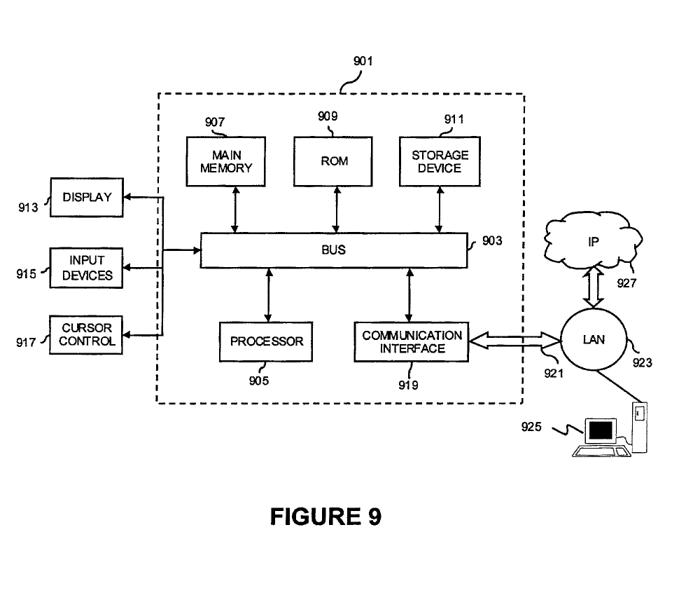

A host computer 100 is provided as an interface between a promotion database 102 an interactive voice response (IVR) system 20, and an Internet connection 106. The host computer 100 is any suitable workstation, server, or other device, such as the computer system 901 of FIG. 9. The host computer 101 communicates to the Internet connection 106 using any suitable protocol and may be implemented using the computer system 901 of FIG. 9, for example.

The IVR system 20 is connected to a consumer telephone 10 and optionally to a consumer telephone printer 30. The IVR system 20 of the present invention utilizes standard interactive or alternatively integrated voice response systems well known in the art. U.S. Pat. Nos. 5,452,341; 5,802,526; and 6,016,336, all disclose systems for interactive or integrated voice response systems, the contents of each of these patents are herein incorporated by reference.

The IVR system 20 of the present invention enables the telephone to act as a promotion-request device. The IVR system 20 asks for the consumer's frequent shopper program identification number (e.g. 119977). Once the consumer enters the frequent shopper program identification number using for example the telephone touch pad or voice recognition, the host computer 100 connects the IVR system 20 into the promotion database 102.

The promotion database 102 is a file that includes records containing information for providing promotions in accordance with the present invention. The records in the promotion database 102 contain fields for associating products in a store with discount promotions for those products. The promotion database 102 also includes operations for searching, sorting, recombining, and other database functions. The promotion database 102 may be implemented as two or more databases, if desired. Periodically (e.g., daily), promotion information stored in the promotion database 102 is retrieved by the host computer 100 and forwarded on to the consumer for promotion selection and request.

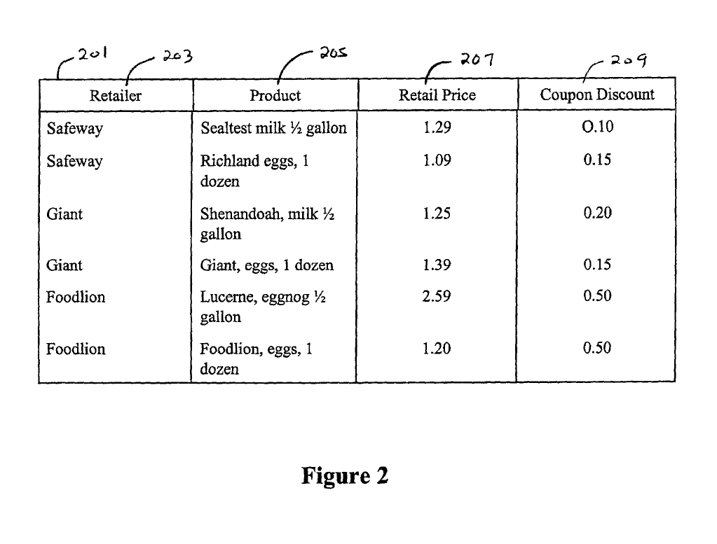

FIG. 2 depicts a promotion discount table 201 stored in the promotional database 102 of the present invention. The promotion table 201 is a data structure depicted in a relational format, whereby information stored in one column (i.e., field) of the table 201 is mapped or linked to information stored in the same row (i.e., record) across the other column(s) of the table 201. These data structures are used by the host computer 100 and/or other network or local computers to provide promotion discounts between various retailers. The promotion discount table 201 forms a portion of the promotion database 102, which is stored in any suitable storage device(s) or medium(s), such as the memory of the host computer 100 and/or any other suitable storage device(s) or medium(s).

The promotion discount table 201 includes a field 203 for storing retail identification, a field 205 for storage product descriptions of the products in field 203, a field 207 for storing the retail prices for products, and a field 209 for storing promotion discounts will be subtracted from the retail prices in the field 207. The host computer 100 selects from the promotion database 102 various retailers nearby the consumer.

Records in the promotion database 102 as well as records in the global purchase database 104 contain fields together with a set of operations for searching, sorting, recombining, and other database functions. One or more of U.S. Pat. Nos. 5,832,457; 5,649,114; 5,430,644; and 5,592,560 describe techniques for collecting consumer purchase history information restoring such information in databases such as the global purchase database 104, for example. U.S. Pat. Nos. 5,832,457; 5,649,114; 5,430,644; and 5,592,560 are incorporated herein by reference. Additionally, techniques for collecting consumer purchase information for storing such information in databases, such as the global purchase database 104 are described in the other patents owned by Catalina Marketing and/or Catalina Marketing International. Each patent owned by Catalina Marketing and/or Catalina Marketing International is incorporated herein by reference.

The host computer 100 via the IVR system 20 interacts in real time with the consumer to interrogate the consumer's promotion requests. The host computer 100 is also connected to a global database 104. The global database 104 is a file that includes records containing information for providing consumer shopping preference information in accordance with the present invention. The records in the global database 104 contain fields for associating purchases in a store with a particular consumer. The global database 104 also includes operations for searching, sorting, recombining, and other database functions. The global database 104 may be implemented as two or more databases, if desired. Periodically (e.g., daily), consumer shopping preference information stored in the global database 104 is retrieved by the host computer 110 to determine which promotion offers will be presented to the consumer. The host computer utilizes consumer shopping preference information to target promotions to consumers for products which the consumer frequently uses. The host computer can also direct promotions to products similar to those products which a particular consumer uses, but heretofore the consumer has not purchased.

The global purchase database 104 includes price information about products at retail stores. Thus, the host computer 100 can not only access discount information available in the promotion database 102 but also can determine, with the price information in the global database 104, the actual purchase price of a product at a particular retail store. The information of price and discount is stored in the promotion database 102.

The host computer 100 prompts consumer to use the telephone touch pad to enter a code that correlates to a particular product category (i.e. cereal code 02). Next, the host computer 100 via the IVR system 20 informs the consumer of offers which are available to the consumer within this product category. The host computer 100 prompts the consumer to press the corresponding button on the phone to accept (i.e. letter A, or # 2) or reject (i.e. letter R or # 7) the promotion offer. The prompting process is repeated until each product that the consumer is interested in is requested. Having completed the selection process, the host computer 100 prompts the consumer to confirm the promotion selections made and inquires about promotion delivery.

According to one embodiment of the present invention, the host computer 100 through the IVR system 20 prompts the consumer to alternative products which may well have more substantial promotion savings. Thus, the present invention provides an advertising medium for new or alternative products. Indeed, in another embodiment of the present invention, the host computer contacts the customer through the IVR system 20 to advertise promotions.

The host computer 100 via the Internet 104 directs the promotions to be issued either at a retail store 108, a consumer fax machine 40, a kiosk 50 for dispensing the promotion (perhaps at an in-store site), or a direct mailer 60 which formats and prints the selected promotions and mails them directly to the consumer. Alternatively, the host computer 100 issues the promotion directly to the consumer's telephone printer 30.

The consumer fax machine 40 is any suitable freestanding fax machine connected to a telephone network or is a fax card inside the user computer 60. The kiosk 50 of the present invention is any kiosk or any other suitable device for dispensing promotions to the consumer such as for example an unattended multimedia kiosk which dispenses promotions via computer screen inputs such as a keyboard, touch screen or both. The direct mailer 60 of the present invention is any direct mailing device or any other suitable device which upon receipt of consumer identification and promotion information prints the promotions and mails the promotions to the consumer.

Should the consumer select to electronically route the promotion directly to the retail store 108, the host computer 100 directs an electronic promotion to a purchase data computer 110 within the retail store 108. The purchase data computer 110 stores records of electronic promotion in a local purchase database 112. The purchase data computer 110 is any suitable workstation, server, or other device, such as the computer system 901 of FIG. 9. The local purchase database 112 is a file that includes records containing information for providing promotion authorization in accordance with the present invention. The records in the local purchase database 102 contain fields for associating products in a store with authorized discount promotions for those products.

The purchase data computer 108 communicates with an in-store printer 114 where the consumer may choose to print a paper copy of all promotions in which the host computer 100 has authorized for redemption at the retail store 108. The purchase data computer 110 also communicates with a terminal 116 and an associated scanner 118. The consumer, choosing not to have a paper copy of the promotions can proceed directly to checkout where products in the local purchase database 112 are identified by the scanner 119, and the consumer automatically receives a discount. The scanner 118 may be implemented as any conventional scanning device for reading product information such as an item code (e.g., UDC, EAN, or JAN) from bar codes or other indicia on the product. Information read by the scanner 118 is transmitted to the purchase data computer 110 via the terminal 116. The terminal 116 may be implemented as a standard cash register and may include a screen, credit card reader, and numeric key pad, for example.

Thus, it is understood that a promotion-request system of the present invention, in general, includes an interactive voice response device (e.g., the IVR 20) which connects a consumer to a host computer including a promotion database, a determination device (e.g. the host computer 100 and the IVR 20) which determines which promotions the consumer requests, and an issuance device (e.g., the telephone printer 30, the consumer fax machine 40, the kiosk 50, or the direct mailer 60) which issues promotions to the consumer.

In another embodiment of the promotion-request system of the present invention, an interactive voice response device (e.g., the IVR 20) contacts a consumer to advertise promotions, a determination device (e.g. the host computer 100) determines which promotions the consumer requests based on promotion request information received from the consumer, and an issuance device (e.g., the telephone printer 30, the fax machine 40, the kiosk 50, or the direct mailer 60) issues promotions to the consumer.

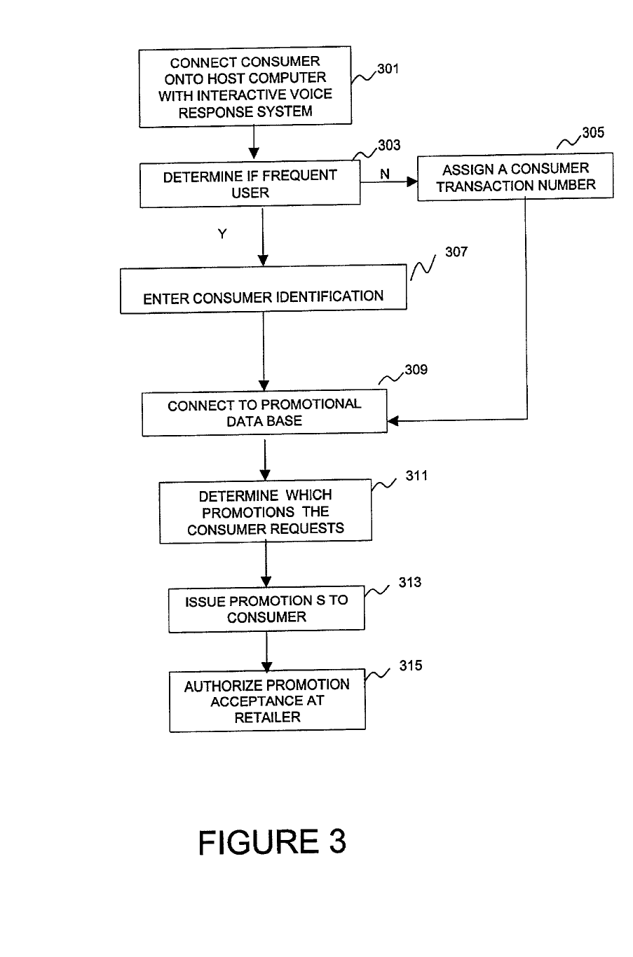

FIG. 3 is a flowchart showing the promotion request method of the present invention. In step 301, the host computer 100 connects a consumer on the telephone 10 via the interactive voice response system 20 to a promotional database. Details of the interactive voice response system have been previously discussed. Once the consumer is connected onto the interactive voice response system 20, in step 303, the host computer 100 determines if the consumer is a frequent shopper. This determination can be made by telephone caller identification available from the phone system or by entering a consumer identification number (e.g., a frequent shopper card number) via the touch pad on a phone. In step 307, the consumer identification is entered. If the consumer is not a member of the frequent shopper program, then as shown in step 305, the host computer 100 assigns a consumer transaction number which tracks the promotion request. The new user, like the frequent shopper, has access, as in step 309, to the promotion database.

In step 311, the host computer 100 through the interactive voice response system 020 interrogates the consumer to determine which promotions the consumer requests based on receiving promotion request information from the consumer. In step 313, the host computer 100 issues the promotions to the consumer. As will be discussed below, the consumer is given choices on how and when to receive the promotions. Regardless, in step 315 the host computer 100 via a connection through the Internet 104 to the purchase data computer 108 at the retail store 106 authorizes acceptance of the promotion at the retail store 106.

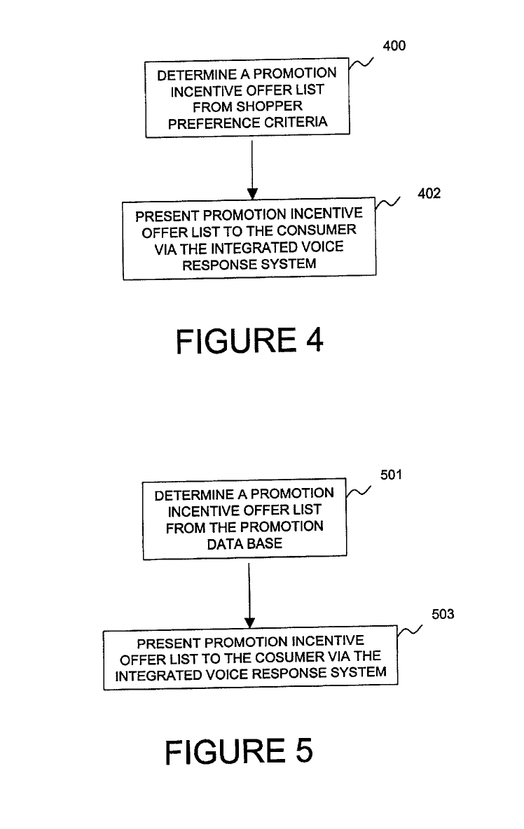

FIG. 4 shows a flowchart showing the promotion request method of the present invention wherein a promotion incentive offer list is generated based on shopper preference criteria. In step 400, the host computer 100 recognizes the consumer from either a frequent shopper identification number or a previous consumer transaction number and determines a promotion incentive offer list based on shopper preference criteria.

The shopper preference criteria determined by the host computer 100 depends from a list of promotions previously requested and/or redeemed by the consumer. According to the present invention, the shopper preference criteria depends on the consumer's past shopping history contained in the global purchase database 104. Thus, according to the present invention, the host computer 100, by recognizing that a consumer frequently buys a particular brand of laundry detergent (e.g., Tide) and determining that the consumer has not redeemed any promotions or discounts on the purchase of the that particular brand, offers a discount coupon to the consumer for that particular brand. Alternatively, the host computer 100 by recognizing that a consumer frequently buys only a particular brand of laundry detergent (e.g., Bold) offers a promotion for an alternative brand.

Regardless, as shown in step 402, the promotion incentive offer list is presented to the consumer via the interactive voice response system 20.

FIG. 5 is a flowchart showing the consumer request method of the present invention wherein the consumer is a new user. In this embodiment, the host computer 100 does not base the promotion offer on shopping preference criteria. Rather, as shown in step 501 the host computer 100 determines a promotion incentive offer list from the promotion database 102. In step 503, the promotion incentive offer list is presented to the consumer by the interactive voice response system 020.

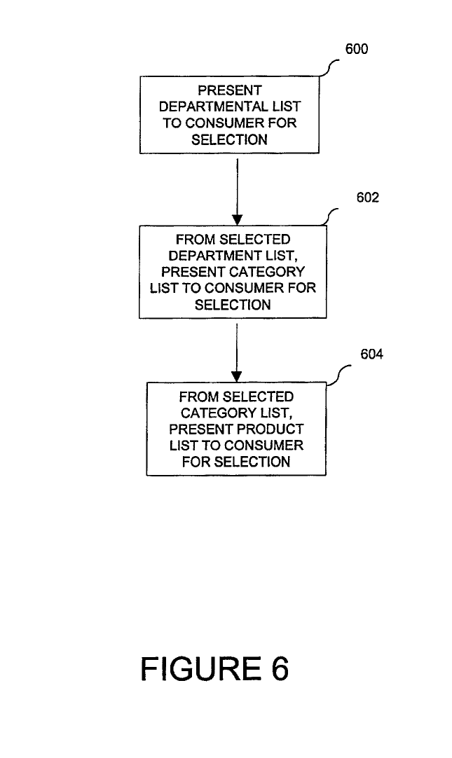

FIG. 6 is a flowchart showing the consumer request method of the present invention illustrating the down selection process of the present invention. In step 600, the host computer 100 presents via the interactive voice response system 20 a departmental list to the consumer for selection. The consumer then selects which department (e.g., automotive, sporting goods, clothing, hardware, housewares, grocery, florist, garden, etc.) in which the consumer wishes to obtain a promotion. Upon the consumer having selected the appropriate department, in step 602, the host computer 100 via the interactive voice system 020 presents a category list to the consumer. The category list includes categories of items within the department list available to the consumer for promotion requests. Such categories in a dairy department might include, for example, cheeses, milks, and eggs. Upon the consumer having selected the appropriate category, in step 604 the host computer 100 via the interactive voice response system 020 presents a product list to the consumer for those products within the department and category in which there are available incentives from a given retailer. As discussed above, in another embodiment of the present invention, the host computer 100 via the interactive voice response system 020 presents other product promotion offers to the consumer in an effort to promote new or alternative products.

The host computer 100 via consumer identification determines retailers in a given shopping district of the consumer and issues promotions valid anywhere within that shopping district or at any national chain.

The present invention stores information relating to various consumers who request promotions utilizing the present invention as well as information regarding consumers' redemption of the issued promotions and the consumer's shopping histories. This information is stored in one or more memories such as a hard disk, optimum disk, magneto optical disk, and/or RAM, for example. One or more databases, such as the promotion database 102 and the global purchase database 104, may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 9, for example.

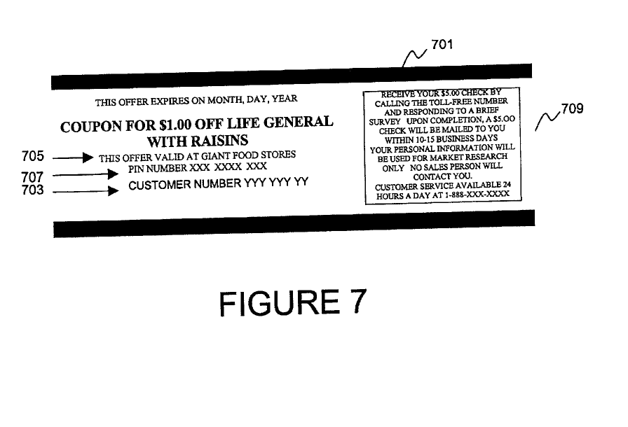

FIG. 7 is an example of purchase promotions that may be printed at the kiosk 050, for example. As shown in FIG. 7, a purchase promotion 701 includes consumer identification information 703, retailer identification 705, and a personal identification number (PIN) 707 unique to the specific purchase to be made at the selected retailer. PIN technology such as described in U.S. Pat. Nos. 5,915,007 and 5,892,827, each of which is incorporated herein by reference, may be used in the present invention.

The purchase promotion offer may, according to the present invention, contain another incentive offer 709, not restricted to merely the purchase of the selected item.

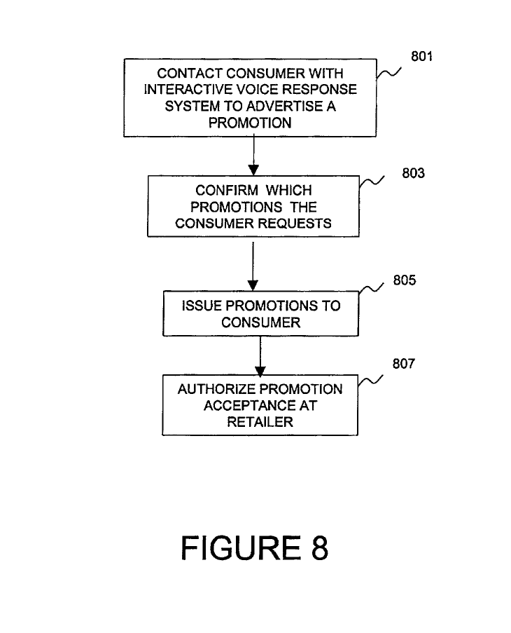

In another embodiment of the present invention, the IVR system 20 contacts a consumer. The consumer may be a member of a frequent shopper program or may be a frequent user of the promotion request system of the present invention. This service is provided to consumers as a mechanism to update the consumers on the latest promotions. FIG. 8 is a flowchart showing this embodiment of the promotion request method. In step 801, the host computer 100 contacts a consumer via the interactive voice response system 20 and the telephone 10 to advertise at least one promotion to the consumer. Once the consumer has been informed of the promotion, in step 803, the host computer 100 confirms which promotions the consumer requests based on promotion request information received from the consumer. In step 805, the host computer 100 issues the promotions to the consumer. As before, the consumer is given choices on how and when to receive the promotion incentives. Regardless, in step 807 the host computer 100 via a connection through the Internet 104 to the purchase data computer 108 at the retail store 106 authorizes acceptance of the promotion at the retail store 106.

The aforesaid methods and devices for the promotion request method of the present invention is, according to this invention, contained on a computer program product. The computer program product is a storage medium including instructions which can be used to program a computer or a plurality of network computers to perform a process of the invention. Storage medium can include but is not limited to, any type of disk including floppy disk, optical disk, CD-ROMs, and magneto optical disk, ROMs, RAMs, EPROMs, EEPROMs, magnetic or optical cards, or any type of means suitable for storing electronic instructions.

This invention can be conveniently implemented easily in a general purpose digital computer or a network of general purpose digital computers and/or microprocessor program to record the teachings of the present invention, as will be apparent to those skilled in the computer art from reading the above descriptions regarding the figures. Appropriate software coding can be readily programmed by skilled programmers based on the teaching of the present disclosure, as will be apparent to those skilled in the software art. The invention may also be implemented by preparation of applications specific interactive circuits or by interconnecting an appropriate network of conventional components of circuits, as will be readily apparent to those skilled in the art.

It is to be understood that the system in FIG. 1 is for exemplary purposes only, as many variations of the specific hardware and software used to implement the present invention will be readily apparent to one having ordinary skill in the art. For example, the functionality of the promotion database 102 and the global purchase database 104 may be combined into a single device. These implementations and other implementations computer systems are described in greater detail in one or more U.S. Pat. Nos. 4,723,212; 4,910,672; 5,173,851; 5,612,868; and 6,026,370, each of which is incorporated herein by reference. To implement these variations as well as other variations, a single computer (e.g., the host computer 100 of FIG. 1) may be programmed to perform the special purpose functions of two or more of any of the devices shown in FIG. 1. On the other hand, two or more programmed computers may be substituted for any one of the devices shown in FIG. 1. Principles and advantages of distributed processing, such as redundancy and replication, may also be implemented as desired to increase the robustness and performance of the system, for example.

FIG. 9 is a schematic illustration of a computer system programmed to perform one or more of the special purpose functions of the present invention. Computer system 901 may be coupled via bus 903 to a display 913, such as a cathode ray tube (CRT), for displaying information to a computer user. The display 913 may be controlled by a display or graphics card. A variety of other display devices can be used such as an LCD (liquid crystal display) or plasma display device. The computer system includes input devices 915, such as a keyboard and a cursor control 917, for communicating information and command selections to processor 905. The cursor control 917, for example, is a mouse, a trackball, or cursor direction keys for communicating direction information and command selections to processor 905 and for controlling cursor movement on the display 913.

The computer system 901 performs a portion or all of the processing steps of the invention in response to processor 905 executing one or more sequences of one or more instructions contained in a memory, such as the main memory 907. Such instructions may be read into the main memory 907 from another computer-readable medium, such as storage device 911. One or more processors in a multi-processing arrangement may also be employed to execute the sequences of instructions contained in main memory 907. In alternative embodiments, hard-wired circuitry may be used in place of or in combination with software instructions. Thus, embodiments are not limited to any specific combination of hardware circuitry and software.

As stated above, the system 901 includes at least one computer readable medium or memory programmed according to the teachings of the invention. Stored on any one or on a combination of computer readable media, the present invention includes software for controlling the computer system 901, for driving a device or devices for implementing the invention, and for enabling the computer system 901 to interact with a human user, e.g., a consumer. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 905 for execution. A computer readable medium may take many forms, including but not limited to, non-volatile media, volatile media, and transmission media Non-volatile media includes, for example, optical, magnetic disks, and magneto-optical disks, such as storage device 911. Volatile media includes dynamic memory, such as main memory 907. Transmission media includes coaxial cables, copper wire and fiber optics, including the wires that comprise bus 903. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 905 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 901 may receive the data on the telephone line and use an infrared transmitter to convert the data to an infrared signal. An infrared detector coupled to bus 903 can receive the data carried in the infrared signal and place the data on bus 903. Bus 903 carries the data to main memory 907, from which processor 905 retrieves and executes the instructions. The instructions received by main memory 907 may optionally be stored on storage device 911 either before or after execution by processor 905.

Computer system 901 also includes a communication interface 919 coupled to bus 803. Communication interface 919 provides a two-way data communication coupling to a network link 921 that is connected to a local network (e.g., LAN 923). For example, communication interface 919 may be a network interface card to attach to any packet switched local area network (LAN). As another example, communication interface 919 may be an asymmetrical digital subscriber line (ADSL) card, an interactive services digital network (ISDN) card, or a modem to provide a data communication connection to a corresponding type of telephone line. Wireless links may also be implemented. In any such implementation, communication interface 919 sends and receives electrical, electromagnetic or optical signals that carry digital data streams representing various types of information.

Network link 921 typically provides data communication through one or more networks to other data devices. For example, network link 921 may provide a connection through LAN 923 to a host computer 925 or to data equipment operated by a service provider, which provides data communication services through an IP (Internet Protocol) network 927 (e.g., the Internet) or any other suitable network using any known protocol (e.g., IPX). LAN 923 and IP network 927 both use electrical, electromagnetic or optical signals that carry digital data streams. The signals through the various networks and the signals on network link 921 and through communication interface 919, which carry the digital data to and from computer system 901, are exemplary forms of carrier waves transporting the information. Computer system 901 can transmit notifications and receive data, including program code, through the network(s), network link 921 and communication interface 919.

Numerous modifications and variations of the present invention are possible in light of the above teachings. It is therefore to be understood that within the scope of the appended claims, the invention may be practiced otherwise than as specifically described herein.

1. A computer-implemented method for requesting promotions, comprising:
connecting a consumer to a host computer through an interactive voice response system and a telephone, said host computer having a promotion database including promotions available to the consumer on an unrestricted basis;
determining, from the promotions available to the consumer on an unrestricted basis, requested promotions in response to receiving promotion request information from the consumer; and
issuing one of the requested promotions to the consumer.

2. The method of claim 1, further comprising the step of:
authorizing a retailer to accept said one of the requested promotions.

3. The method of claim 2, wherein the step of determining requested promotions comprises:
determining, when the consumer is a frequent user, a promotion offer list based on a consumer shopping preference; and
presenting the promotion offer list to the consumer.

4. The method of claim 3, wherein the step of determining a promotion offer list based on shopping preference comprises:
determining previously requested promotions; and
adding to the promotion offer list promotions for products identical to products for which the customer has previously requested promotions.

5. The method of claim 3, wherein the step of determining a promotion offer list based on shopping preference comprises:
determining previously requested promotions; and
adding to the promotion offer list promotions for products similar to products for which the customer has previously requested promotions.

6. The method of claim 3, wherein the step of determining a promotion offer list based on shopping preference comprises:
determining products which the consumer has previously purchased; and
adding to the promotion offer list promotions for previously purchased products.

7. The method of claim 3, wherein the step of determining a promotion offer list based on shopping preference comprises:
determining products which the consumer has previously purchased; and
adding promotions to the promotion offer list for products similar to previously purchased products.

8. The method of claim 3, wherein the step of determining a promotion offer list based on shopping preference comprises:
determining products which the consumer has not previously purchased; and
adding to the promotion offer list promotions for not-previously purchased products.

9. The method of claim 3, wherein the step of presenting the promotion offer list to the consumer comprises:
presenting to the consumer via the interactive voice response system and the telephone a departmental list; and
obtaining from the consumer a selected department.

10. The method of claim 9, further comprising the steps of:
presenting from the selected department a category list; and
obtaining from the consumer a selected category.

11. The method of claim 10, further comprising the steps of:
presenting from the selected category a product list; and
obtaining from the consumer a selected product.

12. The method of claim 11, further comprising:
offering the consumer alternative promotions for the selected product.

13. The method of claim 12, further comprising:
contacting the consumer via the interactive voice response system and the telephone to the promotional database to advertise promotions available to the consumer on products which the consumer typically purchases.

14. The method of claim 3, wherein the step of issuing one of the requested promotions comprises:
determining the shopping district for the consumer based on a telephone caller identification; and
issuing said one of the requested promotions to a retailer within the shopping district.

15. The method of claim 14, wherein the step of issuing one of the requested promotions comprises:
determining the shopping district of a consumer based on an interactive voice input; and
issuing said one of the requested promotions to a retailer within the shopping district.

16. The method of claim 2, wherein the step of determining requested promotions comprises:
determining a promotion offer list from the promotion database; and
presenting the promotion offer list to the consumer.

17. The method of claim 16, wherein the step of issuing one of the requested promotions comprises:
determining the shopping district for the consumer based on a telephone caller identification; and
issuing said one of the requested promotions to a retailer within the shopping district.

18. The method of claim 16, wherein the step of issuing one of the requested promotions comprises:
determining the shopping district of a consumer based on an interactive voice input; and
issuing said one of the requested promotions to a retailer within the shopping district.

19. The method of claim 16, wherein the step of determining requested promotions comprises:
presenting to the consumer via the interactive voice response system and the telephone a departmental list; and
obtaining from the consumer a selected department.

20. The method of claim 19, further comprising the steps of:
presenting from the selected department a category list; and
obtaining from the consumer a selected category.

21. The method of claim 20, further comprising the steps of:
presenting from the selected category a product list; and
obtaining from the consumer a selected product.

22. The method of claim 21, further comprising:
offering the consumer alternative promotions to the selected product.

23. The method of claim 22, further comprising:
contacting the consumer via the interactive voice response system and the telephone to the promotional database to advertise promotions available to the consumer on products which the consumer typically purchases.

24. The method of claim 2, wherein the step of issuing one of the requested promotions comprises:
issuing said one of the requested promotions over the Internet to at least one of a facsimile machine, a kiosk, and a consumer computer.

25. The method of claim 2, wherein the step of issuing one of the requested promotions to the consumer comprises:
issuing said one of the requested promotions to a direct mailer configured to generate and mail the requested promotions to the consumer.

26. The method of claim 2, wherein the step of authorizing the requested promotion comprises:
communicating via an Internet connection a promotion authorization for said one of the requested promotions to the retailer.

27. The method of claim 26, further comprising the steps of:
storing the promotion authorization for said one of the requested promotions in a local purchase database;
identifying the consumer upon checkout at the retailer; and
redeeming said one of the requested promotions upon scanning of an associated purchase item.

28. A computer-implemented method for requesting promotions, comprising:
contacting a consumer via a host computer, an interactive voice response system, and a telephone on a recurrent basis to advertise at least one promotion available to the consumer, said host computer having a promotion database including the advertised promotions;
determining, from the advertised promotions, requested promotions in response to receiving promotion request information from the consumer; and
issuing one of the requested promotions to the consumer.

29. The method of claim 28, further comprising the step of:
authorizing at a retailer to accept said one of the requested promotions.

30. The method of claim 29, wherein the step of determining requested promotions comprises:
presenting to the consumer via the interactive voice response system and the telephone a departmental list for the advertised promotions; and
obtaining from the consumer a selected department.

31. The method of claim 30, further comprising the steps of:
presenting from the selected department a category list for the advertised promotions; and
obtaining from the consumer a selected category.

32. The method of claim 31, further comprising the steps of:
presenting from the selected category a product list for the advertised promotions; and
obtaining from the consumer a selected product.

33. The method of claim 32, further comprising:
offering the consumer alternative promotions to the selected product.

34. The method of claim 29, wherein the step of issuing one of the requested promotions comprises:
determining a shopping district for the consumer based on a telephone caller identification; and
issuing said one of the requested promotions to a retailer within the shopping district.

35. A system for consumer requesting of promotions, comprising:
an interactive voice response system configured to connect a consumer via a telephone to a promotion database of promotions available to the consumer on an unrestricted basis;
a host computer connected to the interactive voice response system and including the promotional database;
a determination device configured to determine requested promotions in response to promotion request information received from the consumer; and
an issuance device configured to issue one of the requested promotions to the consumer.

36. The system of claim 35, further comprising:
an authorization device configured to authorize said one of the requested promotions at a retailer.

37. The system of claim 36, wherein the issuance device is configured to issue promotions over the Internet to at least one of a facsimile machine, a kiosk, and a consumer computer.

38. The system of claim 36, wherein the issuance device is configured to issue promotions to a direct mailer which generates and mails the requested promotions to the consumer.

39. The system of claim 36, wherein the authorization device is configured to communicate to the retailer via an Internet connection a promotion authorization for the issued promotion.

40. The system of claim 39, further comprising:
a storage device configured to store in a local purchase database the promotion authorization for said one of the requested promotions;
a consumer identification device at a retailer checkout configured to identify customers who have requested promotions;
a scanner configured to identify purchase items; and
a redemption device configured to discount the products associates with the requested promotion.

41. A system for consumer requesting of promotions, comprising:
an interactive voice response system configured to contact a consumer via a telephone to advertise at least one promotion available to the consumer;
a host computer having a promotion database including the at least one promotion;
a determination device configured to determine requested promotions in response to receiving promotion request information from the consumer; and
an issuance device configured to issue one of the requested promotions to the consumer.

42. The system of claim 41, further comprising:
an authorization device configured to authorize said one of the requested promotions at a retailer.

43. The system of claim 42 wherein the issuance device is configured to issue the requested promotions over the Internet to at least one of a facsimile machine, a kiosk, and a consumer computer.

44. The system of claim 42, wherein the issuance device is configured to issue the requested promotions to a direct mailer which generates and mails the requested promotions to the consumer.

45. The system of claim 42, wherein the authorization device is configured to communicate to the retailer via an Internet connection a promotion authorization for said one of the requested promotion.

46. The system of claim 45, further comprising:
a storage device configured to store in a local purchase database the promotion authorization for said one of the requested promotions;
a consumer identification device at a retailer checkout configured to identify customers who have requested promotions;
a scanner configured to identify purchase items; and
a redemption device configured to discount the products associated with the requested promotion.

47. A computer program product embodied in a computer readable medium containing program instructions for execution on a computer system, which when executed by the computer system cause the computer system to perform the method recited in any one of claims 1-34.
